(19) United States
(12) Patent Application Publication
(10) Pub. No.: US 2009/0119155 A1
(43) Pub. Date: May 7, 2009

(54) Client relationship manager

(75) Inventors: Bryan M. Reed, Vestavia Hills, AL (US); Christopher M. Dodson, Pelham, AL (US)

Correspondence Address: STEPTOE & JOHNSON LLP, 1330 CONNECTICUT AVENUE, N.W., WASHINGTON, DC, 20036, US

(73) Assignee: Regions Asset Company, Wilmington, DE (US)

(21) Appl. No.: 12/209,636

(22) Filed: Sep. 12, 2008

Related U.S. Application Data
(60) Provisional application No. 60/971,764, filed on Sep. 12, 2007.

(51) Int. Cl. G06Q 10/00; G06Q 40/00

(52) U.S. Cl. 705/10; 705/35

(57) ABSTRACT

A method for managing a client relationship with a financial institution includes collecting information about a client, compiling the information to generate a validation summary, automatically setting expectations regarding account usage and activity of the client based on the information, creating a client profile with a risk determination for the client based on the expectations, routing the client profile with the risk determination for validation, and reviewing the validated client account at a date subsequent to a validation date of the client profile.

This application claims priority under 35 U.S.C. § 119(e) to U.S. Patent Application Ser. No. 60/971,764, filed on Sep. 12, 2007, which is hereby incorporated by reference in its entirety

### TECHNICAL FIELD

The invention relates to a client relationship management system and method used in the financial services industry.

### BACKGROUND

Financial institutions derive its revenue from managing their clients' funds. However, each and every client presents a unique measure of risk to the institution. Non-payment of bills and defaulting on a loan are common ways a client can incur liability to the institution. In a service environment, such as in private banking, where the institution is handling large sums of client funds and clients are in turn authorized to utilize the institutions' services to transact large sums of money, the potential adverse risk can be all the more apparent. Therefore, it is important for institutions to have a way of assessing any risks associated with taking on a prospective client.

### SUMMARY OF THE INVENTION

In general, a client relationship management system or method can provide an objective, streamlined way of collecting and managing client information. The client relationship management system or method can serve as a repository of information to meet regulatory requirements for CIP/KYC and conduct risk assessment. The risk assessment is based on information that is specific to a person and his or her relationship with an institution.

The client relationship management system or method includes identifying a client as being a prospective client, collecting information to complete a client profile, rating the client profile in terms of risk presented to the institution, accepting or rejecting the prospective client based on the completed client profile, and opening the client account if the prospective client is accepted.

The client relationship management system or method can automatically assess the risk associated with the client based on the collected client information. Each client can have an associated client profile stored in the client relationship management system, and each of the profiles can serve as a central repository for reference, update, and use of client data.

In one aspect, a method for managing a client relationship with a financial institution includes collecting information about a client, compiling the information to generate a validation summary, automatically setting expectations regarding client account usage and activity of the client based on the information, creating a client profile with a risk determination for the client based on the expectations, and routing the client profile with the risk determination for validation. The client can be a new client or an existing client.

The client profile can include a plurality of categories. Each of the plurality of categories can include a plurality of information fields. The plurality of information fields can include a required field or an optional field. The plurality of information fields can include an associated point value which determines a risk associated with the client. The risk determination for the client can include one of low, moderate or high.

The plurality of categories in the client profile can include a General Information Category, a Qualification Category, an Employment Category and a Risk Assessment Category.

The General Information Category within the client profile can include information fields relating to the client's identification and location. The information fields in the General Information Category can have a logic background to query for necessary subsequent client information based on previously collected client information.

The Qualification Category within the client profile can establish a baseline of expected activity, and can provide information regarding the source of the client's funds and wealth, and details about the client's relationship (e.g., existing or proposed accounts within the financial institution) with the institution. The Qualification Category within the client profile can include an information field pertaining to the client's net worth, an information field pertaining to the client's investable assets, an information field pertaining to the client's annual income, or an information field pertaining to the client's aggregate relationships with the financial institution.

The Employment Category within the client profile can provide information pertaining to the client's source of wealth and funds. The Risk Assessment Category within the client profile can include a plurality of queries assessing the risk associated with the client based on the client's source of wealth and funds, client's international travel, client's control over the assets of another, out-of-footprint locations, client's accounts with high volumes of movement via wire, client's political status, or any other information that will shed light into client's relationship with the institution.

The validation summary can be updated as the information about the client is collected to identify a missing information field. The validation summary is displayed for each of the categories of the client profile.

The method for managing a client relationship can further include displaying the client profile with the plurality of categories on an operator screen with each of the plurality of categories displayed in tabs. The tabs can be displayed in different colors to indicate whether the category associated with the tab is complete.

The method for managing a client relationship can further include reviewing the validated client account at a date subsequent to a validation date of the client profile. The date of reviewing the validated client account can depend on the risk determination for the client. Reviewing the validated client account at a date subsequent to a validation date of the client profile can include updating the client profile with an updated risk determination, if there is a change in the client information and client relationship with the institution, and setting the subsequent review date based on the updated risk determination.

The client profile with the risk determination can be routed to a sales manager of the financial institution for approval if the risk determination is low, or the client profile with the risk determination can be routed to a sales manager and a compliance manager of the financial institution for approval if the risk determination is moderate or high.

The method for managing a client relationship can further include terminating the client account, if reviewing the validated client account at a date subsequent to a validation date of the client profile yields an unsatisfactory result.

A client relationship management system can include a client information collection terminal configured to collect information about a client, a validation terminal configured to validate the client profile created in the client information collection terminal, and a subsequent review terminal configured to review the validated client account at a date subsequent to a validation date of the client profile.

The client information collection terminal can include a validation summary generator configured to compile the information to generate a validation summary, a client activity expectations generator configured to automatically set expectations regarding account usage and activity of the client based on the information, and a client profile generator configured to create a client profile with a risk determination for the client based on the expectations.

The subsequent review terminal of the client relationship management system can include a client profile updater configured to update the client profile with an updated risk determination, if there is a change in the client information, and a subsequent review date setter configured to set the subsequent review date based on the updated risk determination.

The client relationship management system can further include a client account terminator configured to terminate the validated client account, if the review of the validated client account at a date subsequent to a validation date of the client profile yields an unsatisfactory result.

A computer-readable medium having computer-executable instructions for managing a client relationship with a financial institution can include computer-executable instructions for collecting information about a client, computer-executable instructions for compiling the information to generate a validation summary, computer-executable instructions for automatically setting expectations regarding account usage and activity of the client based on the information, computer-executable instructions for creating a client profile with a risk determination for the client based on the expectations, and computer-executable instructions for routing the client profile with the risk determination for validation.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a flow diagram illustrating a client relationship management method.

FIG. 2 is a block diagram of a client relationship management system.

FIG. 3 exemplarily illustrates a graphical user interface for gathering client's general information.

FIG. 4 exemplarily illustrates a graphical user interface for gathering client's qualification information.

FIG. 5 exemplarily illustrates a graphical user interface for gathering client's employment information.

FIG. 6 exemplarily illustrates a graphical user interface for gathering client's risk assessment information.

FIG. 7 exemplarily illustrates a validation summary window.

FIG. 8 exemplarily illustrates a client profile.

FIG. 9 exemplarily illustrates a graphical user interface for approving and validating a client profile.

FIG. 10 is a flow diagram of a client profile approval and validation process.

FIG. 11 exemplarily illustrates a graphical user interface for subsequent review of a pre-existing client profile.

FIG. 12 is a flow diagram illustrating a review process.

FIG. 13 exemplarily illustrates a graphical user interface for terminating an existing client profile.

FIG. 14 is a flow diagram illustrating a process for terminating an existing client profile.

### DETAILED DESCRIPTION

Although the following detailed description contains many specific details for the purposes of illustration, anyone of ordinary skill in the art will appreciate that many variations and alterations to the following details can be incorporated in the system and methods described herein. Accordingly, the exemplary embodiments described below are set forth without any loss of generality to, and without imposing limitations upon, any claimed invention.

If any given prospective client poses a significant risk of liability to the institution, the prospective client can not be granted an account with the institution. It is also important that risks continue to be monitored for an existing client, as the client's financial state is subject to change over time.

Conventionally, initial client risk assessment for a prospective client was handled manually. That is, the institution collected information regarding the prospective client and an employee of the institution made a subjective determination regarding whether the prospective client should be granted an account based on the collected information. Periodic review and continual assessment of existing client's risk were also handled manually. Once a prospective client was granted an account, the employee of the institution where the client had the account updated the relevant information and determined at that point whether the client should be allowed the privilege of maintaining an account with the institution based on the updated information.

However, such conventional method of assessing client risks is not without drawbacks. First, the risk assessment process can turn out to be overly subjective, since the criteria of information to be collected and the decision to grant an account to a prospective client (also the decision to allow an existing client to continue the use of the account) can entirely depend on the employee of the institution making such decisions. Second, the risk assessment process itself can be an entirely manual process. That is, there is no risk assessment tool which automatically provides a client risk assessment analysis based on the collected information. Both the collection of information and the assessment of client risk have to be performed manually by the employee of the institution for each client. Thus, it is desirable to have an automated system to collect client information and automatically assess any risks based on the collected information.

The exemplary embodiments of the client relationship manager provide a tool with a streamlined client profile. Once created, these client profiles serve as a central repository for reference, updating and use of client data. The client relationship manager conducts a risk assessment of the client's relationship based on the client information gathered in the client profile. The client relationship manager also assists with the creation and tracking of periodic reviews of the client profile.

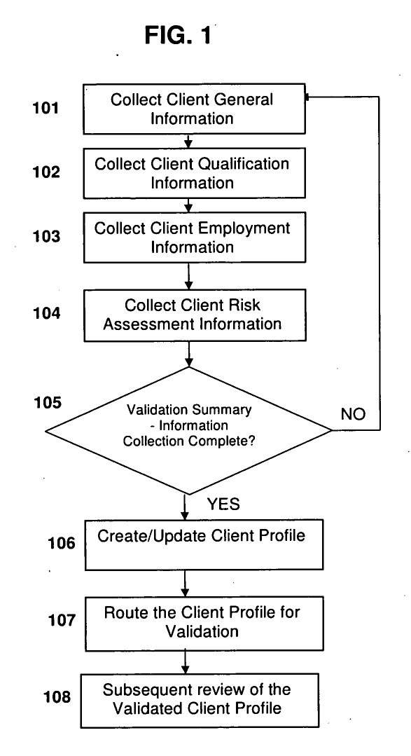

By way of example, FIG. 1 depicts a flow diagram of a client profile creation or update process. The client profile is broken down into four main sections. Each of the four main sections contains various information fields pertaining to client information which can be required or optional. Steps 101-104 depict the four main sections of the client information gathering process necessary to create or update a client profile. Each of the four sections can be displayed with tab headers in a user interface utilized to collect the client information. The tab headers can further include a colored icon which can signal whether each of the tab sections is complete.

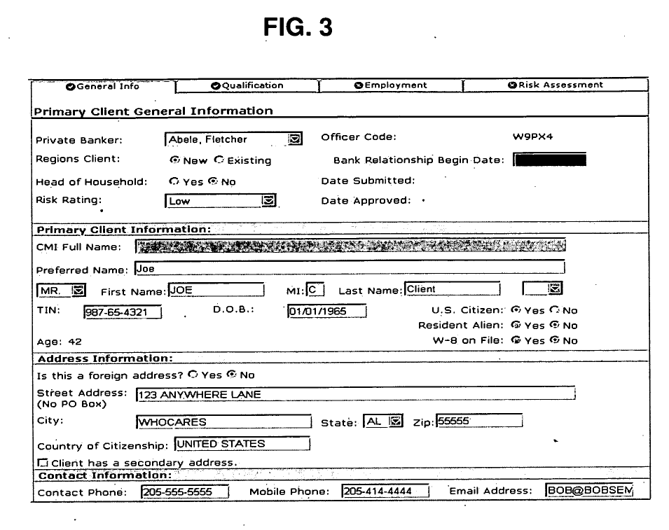

Step 101 depicts the collection of client general information. This section collects and documents information pertaining to the client's identification and location. FIG. 3 illustrates the user interface for gathering the client's general information. As shown in FIG. 3, information regarding client's name, address, date of birth, social security number, or other identifying information are collected. The section also asks about the initial client introduction or referral. The fields shown in FIG. 3 contain logic in the background and will only ask for information needed. An example of this would be a client who is a U.S. citizen and lives in the vicinity of the financial institution will only need to provide one form of identification to be documented. For a client who is a U.S. citizen, but does not live in the vicinity of the financial institution will need to provide two forms of identification, and the client relationship management system will automatically prompt for entry of these information.

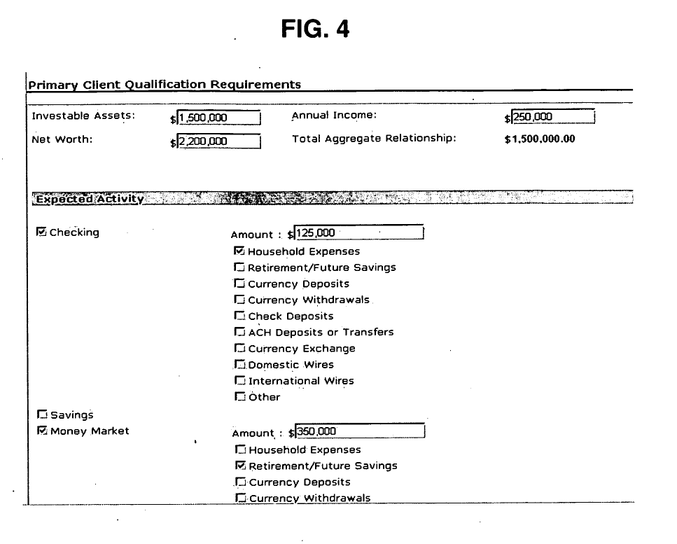

Step 102 depicts the collection of client qualification information. This section collects and documents information pertaining to client's individual situation by detailing the client's net worth, investable assets, annual income, and aggregate relationships. FIG. 4 illustrates the user interface for gathering the client's qualification information. As shown in FIG. 4, the section helps establish a baseline of expected activity, provides information regarding the source of the client's funds and wealth, and details about the client's existing or proposed accounts.

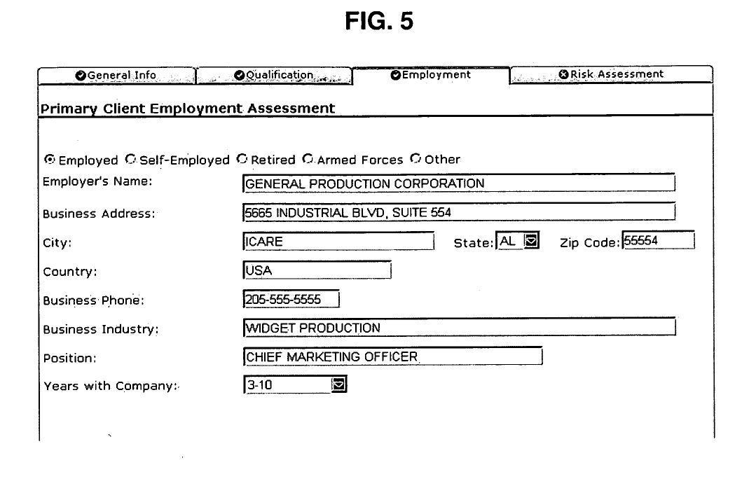

Step 103 depicts the collection of client employment information. The client's employment information provides an understanding of the client's source of wealth and/or source of client's funds, and assists in the Risk Assessment process described below. FIG. 5 illustrates the user interface for gathering the client's employment information. As shown in FIG. 5, information such as name, address and type of business of the client's employer are collected. A client who derives its wealth from a business that is considered high risk will also be considered high risk.

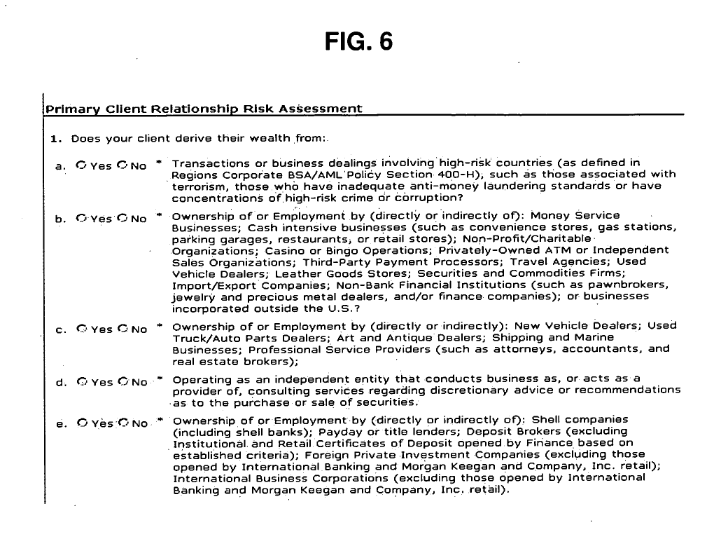

Step 104 depicts the collection of client risk assessment information. FIG. 6 illustrates the user interface for gathering the client's risk assessment information. As shown in FIG. 6, this section contains seven main risk questions. Risk can be tied to the source of the client's wealth (e.g., employment with a prohibited, high, or moderate risk business as determined by the financial institution), international travel, control over the assets of another, out-of-footprint locations, accounts with high volumes of movement via wire, top tier clients, or political status. A positive response to certain questions will result in additional questions being asked to clarify the identified risk.

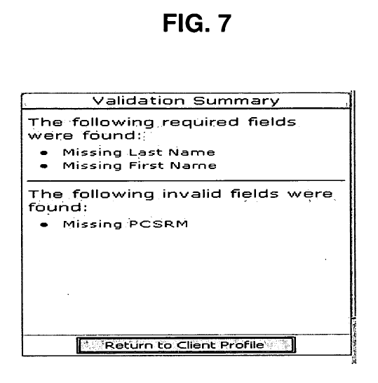

For each of the client information collection process depicted in steps 101-104, the information is compiled and a validation summary is generated for each of the four sections of the client profile in real-time. The validation summary window may be dynamically updated, that is the validation summary is updated in real-time, as the client information is gathered in each of the four sections of the client profile. FIG. 7 illustrates the validation summary window. As shown in FIG. 7, each of the validation summaries keeps track of any missing data present in the four main sections of the client profile. Once the missing data is identified, the system prompts for the missing information until all the necessary client information is collected.

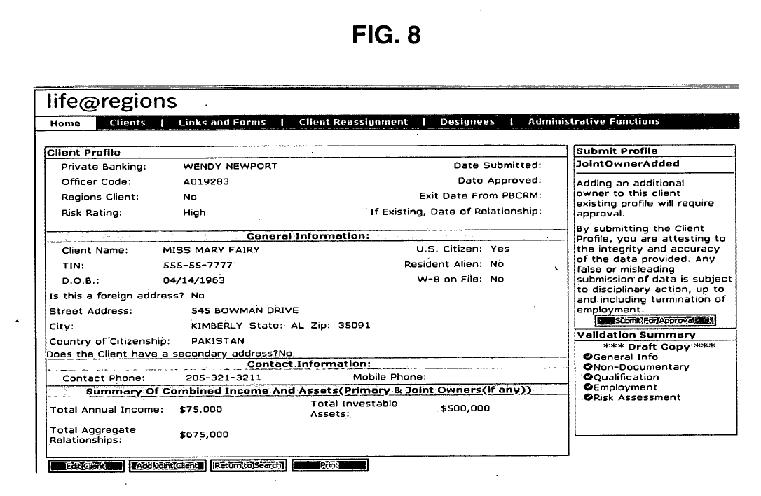

Once the collection and compilation of information is complete, the client profile is created or updated in step 106. FIG. 8 exemplarily illustrates the newly created or updated client profile. The client profile contains various information collected under the four sections of the client information collection process (steps 101-104) along with a risk determination for the client. The risk determination is based on the collected client information, and the risk determination can be either low, moderate or high.

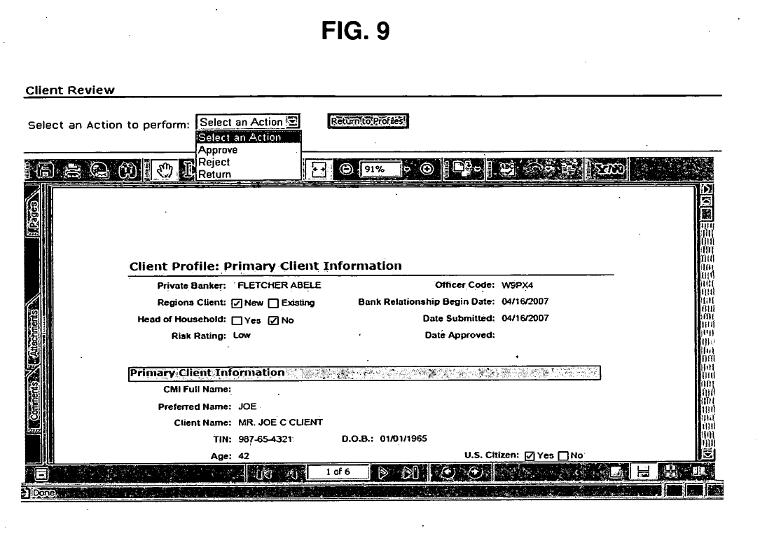

Upon creation of the client profile, the client profile is routed for approval and validation in step 107. Depending on the risk determination of the client, the client profile can be submitted to different authorities for approval. For example, if the risk determination is low, the client profile is submitted to a sales manager of the financial institution. If the risk determination is moderate or high, the client profile is submitted to both a sales manager and a compliance manager of the financial institution. FIG. 9 illustrates the user interface of the sales manager or the compliance manager engaged in the validation process.

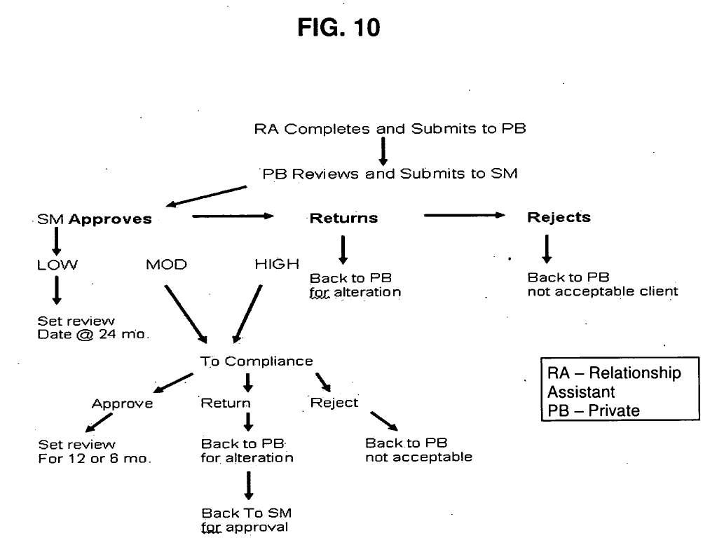

FIG. 10 illustrates the work flow of the approval and validation process. RA denotes a relationship assistant, and PB denotes a private banker. Both the RA and the PB collects the information necessary to create or update a client profile, as described above in steps 101-104. As shown in FIG. 10, during the validation phase, the sales manager or the compliance manager can either approve, reject or return the client profile for further collection of client information.

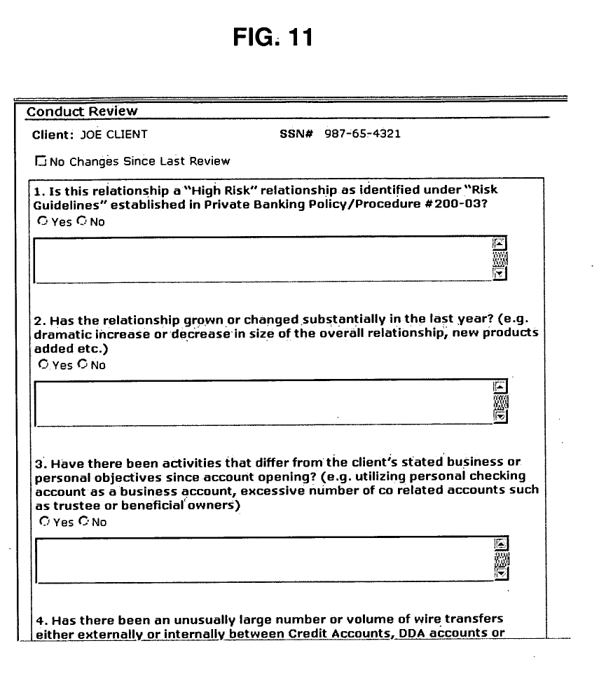

Once the client profile is approved and the client account is established at the financial institution, the client profile is set up for a subsequent review at a date based on the risk determination (step 108). As shown in FIG. 10, a client profile with a low risk determination is set for subsequent review at a date 24 months after the date of validation. A client profile with a moderate risk determination is set for subsequent review at a date 12 months after the date of validation. A client profile with a high risk determination is set for subsequent review at a date 6 months after the date of validation. FIG. 11 illustrates the user interface used for subsequent review of a pre-existing client profile. During the subsequent review process, any new or updated client information that would affect the risk determination associated with the client profile is collected.

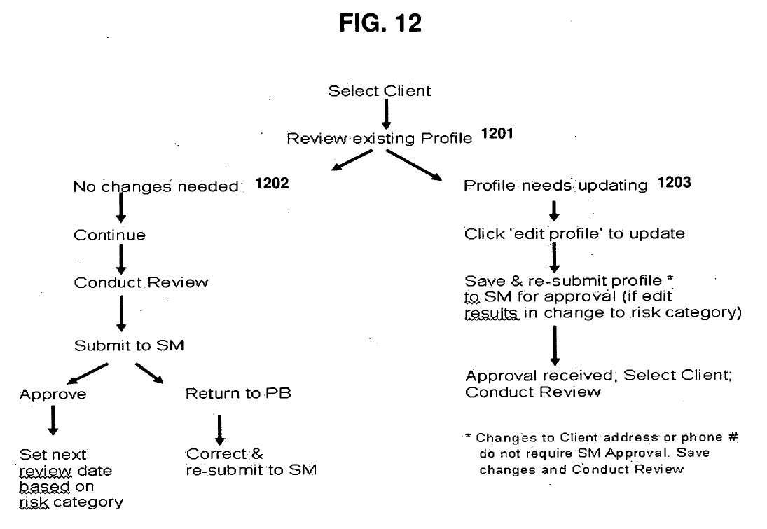

FIG. 12 illustrates the work flow of the review process. At step 1201, the client profile is first reviewed by the reviewing authority and it is determined whether the client profile needs to be updated. If no changes are needed in the client profile (1202), the existing client profile is reviewed and submitted to the sales manager for approval. If, however, the client profile needs to be updated (1203), client information is updated by editing the existing client profile. The updated client profile is then sent to the sales manager for approval.

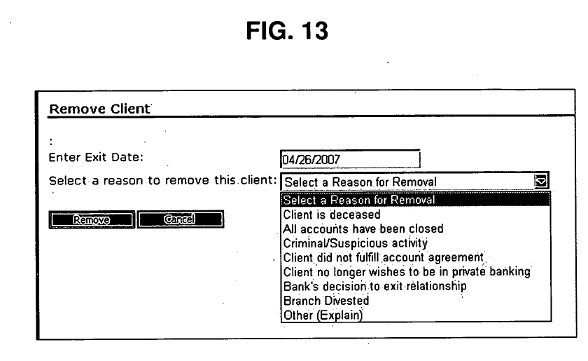

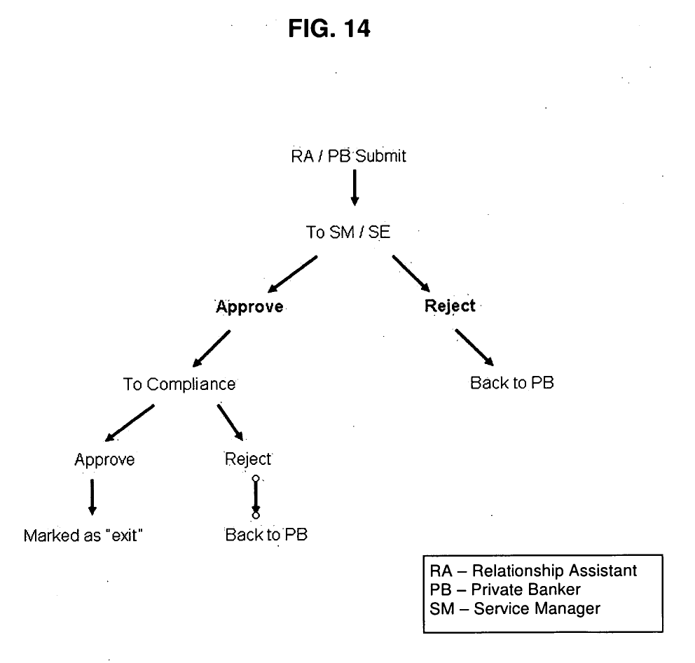

The exemplary embodiment of the client management method can provide for a way to terminate an existing client profile. FIG. 13 illustrates the user interface screen for terminating existing clients. As shown in FIG. 13, the existing client profile can be terminated for various reasons. FIG. 14 illustrates the workflow diagram of the client termination process. First, the relationship assistant or the private banker of the financial institution initiates the client termination request. The sales manager or the sales executive of the financial institution reviews the client termination request. If the termination request is approved, the request is further routed to the compliance manager of the financial institution for a final approval. If the termination request is rejected by either the service manager or the compliance manager, the client profile is routed back to the private banker for further review.

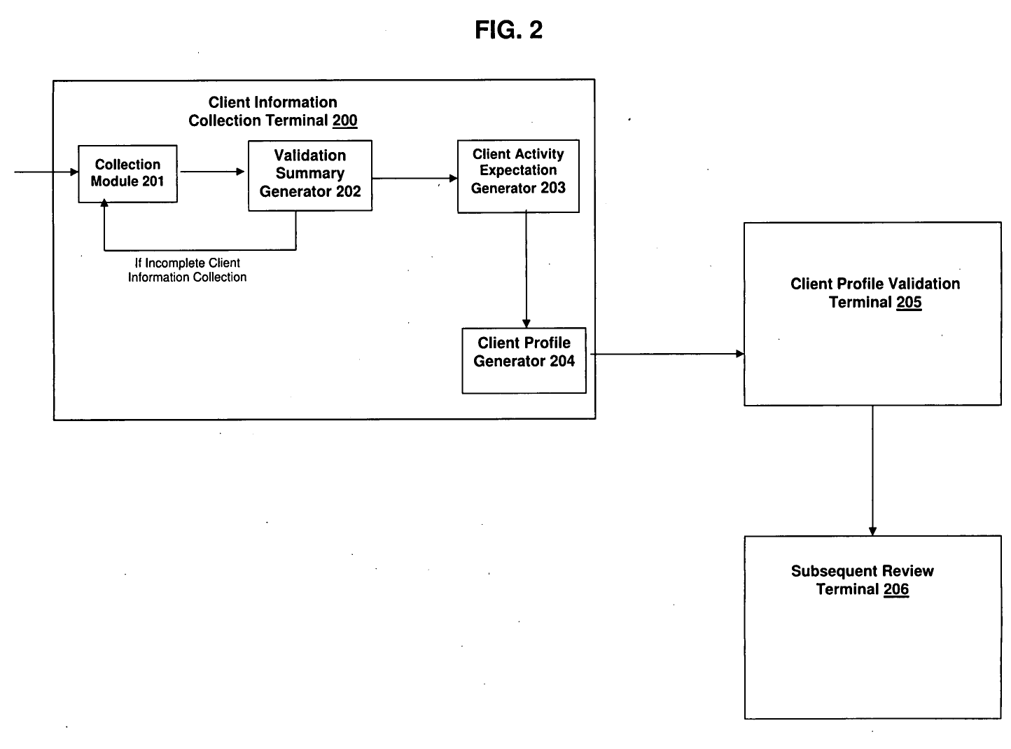

By way of example, FIG. 2 depicts a block diagram of a client relationship management system. The client relationship management system includes the client information collection terminal 200, the client profile validation terminal 205, and subsequent review terminal 206.

The client information collection terminal 200 includes the collection module 201, the validation summary generator 202, the client activity expectation generator 203, and the client profile generator 204. The collection module 201 collects the four stages of client information necessary to generate a client profile, as described in steps 101-104 above.

The validation summary generator 202 compiles, in real-time, the collected information and checks for any incomplete client information in each of the four sections of the client profile. If any client information is missing, the validation summary generator prompts for the missing client information by routing the work flow back to the collection module 201. The functionality of the validation summary generator 202 is equivalent to those described in step 105.

Once client information is collected and compiled, the client activity expectation generator 203 automatically sets the client expectations. The client profile generator 204 then generates a client profile with a risk determination. The functionality of the client activity expectation generator 203 and the client profile generator 204 are equivalent to those described in step 106.

The created profile is then sent to the client profile validation terminal 205 for validation. As described in step 107, the client profile validation terminal can be the service manager or the compliance manger depending on the risk determination associated with the client profile.

Once the created profile is validated, the profile is set for a subsequent review by the subsequent review terminal 206. The actual date of subsequent review of the client profile can vary depending on the risk determination associated with the client profile, as described in steps 108 and 1201-1203. By reviewing the existing client profile at the subsequent review terminal 206, the financial institution can capture any change in client information that would impact the risk determination associated with each of the existing client profiles.

The various techniques, methods, and systems described above can be implemented in part or in whole using computer-based systems and methods. Additionally, computer-based systems and methods can be used to augment or enhance the functionality described above, increase the speed at which the functions can be performed, and provide additional features and aspects as a part of or in addition to those described elsewhere in this document. Various computer-based systems, methods and implementations in accordance with the above-described technology are presented below.

In one implementation, a general-purpose computer can have an internal or external memory for storing data and programs such as an operating system (e.g., DOS, Windows 2000™, Windows XP™, Windows NT™, OS/2, UNIX or Linux) and one or more application programs. Examples of application programs include computer programs implementing the techniques described herein, authoring applications (e.g., word processing programs, database programs, spreadsheet programs, or graphics programs) capable of generating documents or other electronic content; client applications (e.g., an Internet Service Provider (ISP) client, an e-mail client, or an instant messaging (IM) client) capable of communicating with other computer users, accessing various computer resources, and viewing, creating, or otherwise manipulating electronic content; and browser applications (e.g., Microsoft's Internet Explorer) capable of rendering standard Internet content and other content formatted according to standard protocols such as the Hypertext Transfer Protocol (HTTP).

One or more of the application programs can be installed on the internal or external storage of the general-purpose computer. Alternatively, in another implementation, application programs can be externally stored in and/or performed by one or more device(s) external to the general-purpose computer.

The general-purpose computer includes a central processing unit (CPU) for executing instructions in response to commands, and a communication device for sending and receiving data. One example of the communication device is a modem. Other examples include a transceiver, a communication card, a satellite dish, an antenna, a network adapter, or some other mechanism capable of transmitting and receiving data over a communications link through a wired or wireless data pathway.

The general-purpose computer can include an input/output interface that enables wired or wireless connection to various peripheral devices. Examples of peripheral devices include, but are not limited to, a mouse, a mobile phone, a personal digital assistant (PDA), a keyboard, a display monitor with or without a touch screen input, and an audiovisual input device. In another implementation, the peripheral devices can themselves include the functionality of the general-purpose computer. For example, the mobile phone or the PDA can include computing and networking capabilities and function as a general purpose computer by accessing the delivery network and communicating with other computer systems. Examples of a delivery network include the Internet, the World Wide Web, WANs, LANs, analog or digital wired and wireless telephone networks (e.g., Public Switched Telephone Network (PSTN), Integrated Services Digital Network (ISDN), and Digital Subscriber Line (xDSL)), radio, television, cable, or satellite systems, and other delivery mechanisms for carrying data. A communications link can include communication pathways that enable communications through one or more delivery networks.

In one implementation, a processor-based system (e.g., a general-purpose computer) can include a main memory, preferably random access memory (RAM), and can also include a secondary memory. The secondary memory can include, for example, a hard disk drive and/or a removable storage drive, representing a floppy disk drive, a magnetic tape drive, an optical disk drive, etc. The removable storage drive reads from and/or writes to a removable storage medium. A removable storage medium can include a floppy disk, magnetic tape, optical disk, etc., which can be removed from the storage drive used to perform read and write operations. As will be appreciated, the removable storage medium can include computer software and/or data.

In alternative embodiments, the secondary memory can include other similar means for allowing computer programs or other instructions to be loaded into a computer system. Such means can include, for example, a removable storage unit and an interface. Examples of such can include a program cartridge and cartridge interface (such as the found in video game devices), a removable memory chip (such as an EPROM or PROM) and associated socket, and other removable storage units and interfaces, which allow software and data to be transferred from the removable storage unit to the computer system.

In one embodiment, the computer system can also include a communications interface that allows software and data to be transferred between computer system and external devices. Examples of communications interfaces can include a modem, a network interface (such as, for example, an Ethernet card), a communications port, and a PCMCIA slot and card. Software and data transferred via a communications interface are in the form of signals, which can be electronic, electromagnetic, optical or other signals capable of being received by a communications interface. These signals are provided to communications interface via a channel capable of carrying signals and can be implemented using a wireless medium, wire or cable, fiber optics or other communications medium. Some examples of a channel can include a phone line, a cellular phone link, an RF link, a network interface, and other suitable communications channels.

In this document, the terms “computer program medium” and “computer usable medium” are generally used to refer to media such as a removable storage device, a disk capable of installation in a disk drive, and signals on a channel. These computer program products provide software or program instructions to a computer system.

Computer programs (also called computer control logic) are stored in the main memory and/or secondary memory. Computer programs can also be received via a communications interface. Such computer programs, when executed, enable the computer system to perform the features as discussed herein. In particular, the computer programs, when executed, enable the processor to perform the described techniques. Accordingly, such computer programs represent controllers of the computer system.

In an embodiment where the elements are implemented using software, the software can be stored in, or transmitted via, a computer program product and loaded into a computer system using, for example, a removable storage drive, hard drive or communications interface. The control logic (software), when executed by the processor, causes the processor to perform the functions of the techniques described herein.

In another embodiment, the elements are implemented primarily in hardware using, for example, hardware components such as PAL (Programmable Array Logic) devices, application specific integrated circuits (ASICs), or other suitable hardware components. Implementation of a hardware state machine so as to perform the functions described herein will be apparent to a person skilled in the relevant art(s). In yet another embodiment, elements are implanted using a combination of both hardware and software.

In another embodiment, the computer-based methods can be accessed or implemented over the World Wide Web by providing access via a Web Page to the methods described herein. Accordingly, the Web Page is identified by a Universal Resource Locator (URL). The URL denotes both the server and the particular file or page on the server. In this embodiment, it is envisioned that a client computer system interacts with a browser to select a particular URL, which in turn causes the browser to send a request for that URL or page to the server identified in the URL. Typically the server responds to the request by retrieving the requested page and transmitting the data for that page back to the requesting client computer system (the client/server interaction is typically performed in accordance with the hypertext transport protocol or HTTP). The selected page is then displayed to the user on the client's display screen. The client can then cause the server containing a computer program to launch an application to, for example, perform an analysis according to the described techniques. In another implementation, the server can download an application to be run on the client to perform an analysis according to the described techniques.

Although the systems and methods have been described in detail, it will be apparent to those of skill in the art that the systems and methods can be embodied in a variety of specific forms and that various changes, substitutions, and alterations can be made without departing from the spirit and scope of the systems and methods described herein. The described embodiments are only illustrative and not restrictive and the scope of the systems and methods is, therefore, indicated by the following claims. Other embodiments are within the scope of the following claims.

What is claimed is:

1. A method for managing a client relationship with a financial institution, the method comprising:
collecting information about a client;
compiling the information to generate a validation summary;
automatically setting expectations regarding account usage and activity of the client based on the information;
creating a client profile with a risk determination for the client based on the expectations; and
routing the client profile with the risk determination for validation.

2. The method according to claim 1, the method further comprising reviewing the validated client account at a date subsequent to a validation date of the client profile.

3. The method according to claim 1, wherein the client is a new client.

4. The method according to claim 1, wherein the client is an existing client.

5. The method according to claim 2, wherein the client profile comprises a plurality of categories.

6. The method according to claim 5, wherein each of the plurality of categories comprises a plurality of information fields.

7. The method according to claim 6, wherein the plurality of information fields includes a required field.

8. The method according to claim 7, wherein the plurality of information fields includes an optional field.

9. The method according to claim 8, wherein the plurality of information fields includes an associated point value which determines a risk associated with the client.

10. The method according to claim 9, wherein the plurality of categories in the client profile includes a General Information Category, a Qualification Category, an Employment Category and a Risk Assessment Category.

11. The method according to claim 10, wherein the General Information Category within the client profile comprises information fields relating to the client's identification and location.

12. The method according to claim 11, wherein the information fields in the General Information Category have a logic background to query for necessary subsequent client information based on previously collected client information.

13. The method according to claim 12, wherein the validation summary is updated as the information about the client is collected to identify a missing information field.

14. The method according to claim 13, wherein the validation summary is updated in real-time as each of the categories of the client profile is updated.

15. The method according to claim 14, the method further comprising displaying the client profile with the plurality of categories on an operator screen with each of the plurality of categories displayed in tabs.

16. The method according to claim 15, wherein the tabs are displayed in different colors to indicate whether the category associated with the tab is complete.

17. The method according to claim 16, wherein the Qualification Category within the client profile establishes a baseline of expected activity, provides information regarding the source of the client's funds and wealth, and details about the client's existing or proposed accounts within the financial institution.

18. The method according to claim 17, wherein the Qualification category within the client profile comprises:
an information field pertaining to the client's net worth;
an information field pertaining to the client's investable assets;
an information field pertaining to the client's annual income; and
an information field pertaining to the client's aggregate relationships with the financial institution.

19. The method according to claim 18, wherein the Employment category within the client profile provides information pertaining to the client's source of wealth and funds.

20. The method according to claim 19, wherein the Risk Assessment category within the client profile comprises a plurality of queries assessing the risk associated with the client based on the client's source of wealth and funds, client's international travel, client's control over the assets of another, out-of-footprint locations, client's accounts with high volumes of movement via wire, and client's political status.

21. The method according to claim 20, wherein the risk determination for the client includes one of low, moderate and high.

22. The method according to claim 21, wherein the client profile with the risk determination is routed to a sales manager of the financial institution for approval if the risk determination is low, and the client profile with the risk determination is routed to a sales manager and a compliance manager of the financial institution for approval if the risk determination is moderate or high.

23. The method according to claim 22, wherein the date of reviewing the validated client account depends on the risk determination for the client.

24. The method according to claim 23, wherein the reviewing the validated client account at a date subsequent to a validation date of the client profile comprises:
updating the client profile with an updated risk determination, if there is a change in the client information; and
setting the subsequent review date based on the updated risk determination.

25. The method according to claim 24, the method further comprising terminating the client account, if the reviewing the validated client account at a date subsequent to a validation date of the client profile yields an unsatisfactory result.

26. A client relationship management system, the system comprising:
a client information collection terminal configured to collect information about a client, the client information collection terminal comprising:
a validation summary generator configured to compile the information to generate a validation summary;
a client activity expectations generator configured to automatically set expectations regarding account usage and activity of the client based on the information;
a client profile generator configured to create a client profile with a risk determination for the client based on the expectations;
a validation terminal configured to validate the client profile created in the client information collection terminal; and
a subsequent review terminal configured to review the validated client account at a date subsequent to a validation date of the client profile.

27. The system according to claim 25, wherein the client is a new client.

28. The system according to claim 27, wherein the client is an existing client.

29. The system according to claim 26, wherein the client profile comprises a plurality of categories.

30. The system according to claim 29, wherein each of the plurality of categories comprises a plurality of information fields.

31. The system according to claim 30, wherein the plurality of information fields includes a required field.

32. The system according to claim 31, wherein the plurality of information fields includes an optional field.

33. The system according to claim 32, wherein the plurality of information fields includes an associated point value which determines a risk associated with the client.

34. The system according to claim 33, wherein the plurality of categories in the client profile includes a General Information Category, a Qualification Category, an Employment Category and a Risk Assessment Category.

35. The system according to claim 34, wherein the General Information Category within the client profile comprises information fields relating to the client's identification and location.

36. The system according to claim 35, wherein the information fields in the General Information Category have a logic background to query for necessary subsequent client information based on previously collected client information.

37. The system according to claim 36, wherein the validation summary generator is configured to update the validation summary as the information about the client is collected to identify a missing information field.

38. The system according to claim 37, wherein the validation summary generator updates the validation summary for each of the categories of the client profile in real-time as each of the categories of the client profile is updated.

39. The system according to claim 38, wherein the client profile generator is configured to display the client profile with the plurality of categories on an operator screen of the client information collection terminal with each of the plurality of categories displayed in tabs.

40. The system according to claim 39, wherein the client profile generator is configured to display the tabs in different colors to indicate whether the category associated with the tab is complete.

41. The system according to claim 40, wherein the Qualification Category within the client profile is configured to establish a baseline of expected activity, and provide information regarding the source of the client's funds and wealth details about the client's existing or proposed accounts within the financial institution.

42. The system according to claim 41, wherein the Qualification category within the client profile comprises:
an information field pertaining to the client's net worth;
an information field pertaining to the client's investable assets;
an information field pertaining to the client's annual income; and
an information field pertaining to the client's aggregate relationships with the financial institution.

43. The system according to claim 42, wherein the Employment category within the client profile provides information pertaining to the client's source of wealth and funds.

44. The system according to claim 43, wherein the Risk Assessment category within the client profile comprises a plurality of queries assessing the risk associated with the client based on the client's source of wealth and funds, client's international travel, client's control over the assets of another, out-of-footprint locations, client's accounts with high volumes of movement via wire, and client's political status.

45. The system according to claim 44, wherein the risk determination for the client includes one of low, moderate and high.

46. The system according to claim 45, wherein the client profile generator is configured to forward the client profile to the validation terminal for validation if the risk determination is low.

47. The system according to claim 45, wherein the client profile generator is configured to forward the client profile to the validating terminal and a compliance manager of the financial institution for validation if the risk determination is moderate or high.

48. The system according to claim 47, wherein the subsequent review terminal is configured to set the date of reviewing the validated client account based on the risk determination for the client.

49. The system according to claim 48, wherein the subsequent review terminal comprises:
a client profile updater configured to update the client profile with an updated risk determination, if there is a change in the client information; and
a subsequent review date setter configured to set the subsequent review date based on the updated risk determination.

50. The system according to claim 49, the system further comprising a client account terminator configured to terminate the validated client account, if the review of the validated client account at a date subsequent to a validation date of the client profile yields an unsatisfactory result.

51. A computer-readable medium having computer-executable instructions for managing a client relationship with a financial institution, the computer-readable medium comprising:
computer-executable instructions for collecting information about a client;
computer-executable instructions for compiling the information to generate a validation summary;
computer-executable instructions for automatically setting expectations regarding account usage and activity of the client based on the information;
computer-executable instructions for creating a client profile with a risk determination for the client based on the expectations; and
computer-executable instructions for routing the client profile with the risk determination for validation.

52. The computer-readable medium according to claim 51 further comprising computer-executable instructions for reviewing the validated client account at a date subsequent to a validation date of the client profile.

53. The computer-readable medium according to claim 52, wherein the client is a new client.

54. The computer-readable medium according to claim 53, wherein the client is an existing client.

55. The computer-readable medium according to claim 54, wherein the client profile comprises a plurality of categories.

56. The computer-readable medium according to claim 54, wherein each of the plurality of categories comprises a plurality of information fields.

57. The computer-readable medium according to claim 56, wherein the plurality of information fields includes a required field.

58. The computer-readable medium according to claim 57, wherein the plurality of information fields includes an optional field.

59. The computer-readable medium according to claim 58, wherein the plurality of information fields includes an associated point value which determines a risk associated with the client.

60. The computer-readable medium according to claim 59, wherein the plurality of categories in the client profile includes a General Information Category, a Qualification Category, an Employment Category and a Risk Assessment Category.

61. The computer-readable medium according to claim 60, wherein the General Information Category within the client profile comprises information fields relating to the client's identification and location.

62. The computer-readable medium according to claim 61, wherein the information fields in the General Information Category have a logic background to query for necessary subsequent client information based on previously collected client information.

63. The computer-readable medium according to claim 62, wherein the validation summary is updated as the information about the client is collected to identify a missing information field.

64. The computer-readable medium according to claim 63, wherein the validation summary is updated in real-time as each of the categories of the client profile is updated.

65. The computer-readable medium according to claim 64, the computer-readable medium further comprising computer-executable instructions for displaying the client profile with the plurality of categories on an operator screen with each of the plurality of categories displayed in tabs.

66. The computer-readable medium according to claim 65, wherein the tabs are displayed in different colors to indicate whether the category associated with the tab is complete.

67. The computer-readable medium according to claim 66, wherein the Qualification Category within the client profile establishes a baseline of expected activity, provides information regarding the source of the client's funds and wealth, and details about the client's existing or proposed accounts within the financial institution.

68. The computer-readable medium according to claim 67, wherein the Qualification category within the client profile comprises:
an information field pertaining to the client's net worth;
an information field pertaining to the client's investable assets;
an information field pertaining to the client's annual income; and
an information field pertaining to the client's aggregate relationships with the financial institution.

69. The computer-readable medium according to claim 68, wherein the Employment category within the client profile provides information pertaining to the client's source of wealth and funds.

70. The computer-readable medium according to claim 69, wherein the Risk Assessment category within the client profile comprises a plurality of queries assessing the risk associated with the client based on the client's source of wealth and funds, client's international travel, client's control over the assets of another, out-of-footprint locations, client's accounts with high volumes of movement via wire, and client's political status.

71. The computer-readable medium according to claim 70, wherein the risk determination for the client includes one of low, moderate and high.

72. The computer-readable medium according to claim 71, wherein the client profile with the risk determination is routed to a sales manager of the financial institution for approval if the risk determination is low, and the client profile with the risk determination is routed to a sales manager and a compliance manager of the financial institution for approval if the risk determination is moderate or high.

73. The computer-readable medium according to claim 72, wherein the date of reviewing the validated client account depends on the risk determination for the client.

74. The computer-readable medium according to claim 73, wherein the computer-executable instructions for reviewing the validated client account at a date subsequent to a validation date of the client profile comprises:
computer-executable instructions for updating the client profile with an updated risk determination, if there is a change in the client information; and
computer-executable instructions for setting the subsequent review date based on the updated risk determination.

75. The computer-readable medium according to claim 74, the computer-readable medium further comprising computer-executable instructions for terminating the client account, if the reviewing the validated client account at a date subsequent to a validation date of the client profile yields an unsatisfactory result.
